(19) United States
(12) Patent Application Publication
(10) Pub. No.: US 2005/0184541 A1
(43) Pub. Date: Aug. 25, 2005

(54) BLADE CONNECTORS FOR AN INTERCHANGEABLE DRYWALL TOOL EXTENSION SYSTEM

(76) Inventor: Randall Grizzle, MERIDIAN, ID (US)

Correspondence Address: DYKAS, SHAVER & NIPPER, LLP, P.O. BOX 877, 802 WEST BANNOCK STREET, SUITE 405, BOISE, ID, 83701, US

(21) Appl. No.: 10/906,124

(22) Filed: Mar. 9, 2005

Related U.S. Application Data
(63) Continuation-in-part of application No. 10/193,650, filed on Jul. 10, 2002.
(60) Provisional application No. 60/304,804, filed on Jul. 10, 2001.

(51) Int. Cl. B25J 1/00

(52) U.S. Cl. 294/19.1

(57) ABSTRACT

A drywall extension system that is able to be used with commonly existing drywall tools. The system has a telescoping pole outfitted with a bushing, which is inserted into the first end of the pole. The bushing is attached therein through use of at least one crimp. This bushing is threaded so as to receive common drywall tools containing threaded ends, such as sanders, nail spotters, and the like.

### PRIORITY

This application claims the priority date of the utility application entitled Interchangeable Drywall Tool Extension System filed by Randall Grizzle on Jul. 10, 2002 with application Ser. No. 10/193,650, which claims priority from the provisional application entitled Interchangeable Drywall Tool Extension System filed by Randall Grizzle on Jul. 10, 2001 with application Ser. No. 60/304,804, and the provisional application entitled Blade Connectors for an Interchangeable Drywall Tool Extension System filed by Randall Grizzle on Jun. 17, 2004 with application Ser. No. 60/581,146.

### FIELD OF THE INVENTION

The present invention generally relates to construction tools, and more particularly to tools used in the drywall finishing trade.

### BACKGROUND INFORMATION

It is well known that in order to achieve smooth seams in the areas where sheets and drywall are abutted, the joints must be taped and a finishing compound/drywall “mud” must be applied over the taped joints. The finishing compound is then sanded to provide the smooth finish for painting and/or texturing. The application of finishing compound is typically accomplished by hand or by using a “skim box” which is filled with the finishing compound and attached to a handle or extension pole. The skim box, which includes a spring loaded finishing compound ejecting plate, is pressed against the drywall surface while it is moved along the joint in order to apply finishing compound in the area of the joint. The pressure applied to the skim box causes the finishing compound to be forced onto the drywall surface and into the joint. There are other types of drywall finishing tools including sanders and other corner finishers.

In order to finish joints on extended or high walls, or in other areas that are difficult to reach, a ladder or scaffolding can be employed. However, safety, as well as the amount of time required to move from one location to another, makes the use of a ladder or scaffolding undesirable. Therefore, extension poles are used while the user stands on the floor. Such extension poles used in the industry comprise either long lengths of rigid poles or a plurality of rigid poles that can be screwed together to make the length longer.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a drywall extension system that can be used with commonly existing drywall tools. The present invention has a telescoping pole outfitted with a bushing, which is inserted into the first end of the pole. This bushing is threaded so as to receive common drywall tools containing threaded ends. In an alternative embodiment, the bushing has the drywall tool connecting means extending therefrom.

In another embodiment of the present invention, the present invention is an interchangeable tool extension system for allowing a number of tool heads to be interchangeably used with one pole. This system comprising a telescoping, cylindrical tubular pole and a cylindrical bushing. The telescoping, cylindrical tubular pole having a first end extending to a second end. The tubular pole second end comprising a handle.

The cylindrical bushing is for connecting a tool head with the pole. The bushing having a cylindrical body able to interfit within the pole's first end. This bushing having an outer surface having an annular grove therein. To attach the bushing within the pole at least one crimp is made in the pole at the location of the bushing groove thereby fixing the bushing within the pole. The bushing having a first end extending to a second end. The bushing first end installed and fixed within the pole adjacent the pole's first end.

The bushing first end defining an opening therein and into said bushing. This opening connecting with a threaded tool head attachment for allowing a tool head having a threaded post to be screwed into the bushing. Additionally, it is preferred that the bushing have a rim on its outer surface adjacent said opening, this rim contacting the pole first end.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature and not as restrictive.

### BRIEF DESCRIPTION OF THE DRAWINGS

FIG. 1 is a partial, side view of a telescoping handle of the present invention.

FIG. 2 is a close up of one embodiment of the present invention.

FIG. 3 is a perspective view of a first embodiment of an interchangeable head of the present invention.

FIG. 4A is a side view of a second embodiment of an interchangeable head of the present invention.

FIG. 4B is a side view of a third embodiment of an interchangeable head of the present invention.

FIG. 4C is a side view of a fourth embodiment of an interchangeable head of the present invention.

FIG. 5 is a first end view of the interchangeable head of FIG. 4A.

FIG. 6 is a second end view of the interchangeable head of FIG. 4A.

FIG. 7 is a side view of one embodiment of an attachment utilized with the present invention.

FIG. 8 is a side view of a second embodiment of an attachment utilized with the present invention.

FIG. 9 is a side view of a fifth embodiment of an interchangeable head of the present invention shown installed on a pole and able to attach to an attachment.

FIG. 10 is a perspective view of a sixth embodiment of the interchangeable head of the present invention.

FIG. 11 is a first side view of the embodiment shown in FIG. 10.

FIG. 12 is a second side view of the embodiment shown in FIG. 10.

FIG. 13 is a third side view of the embodiment shown in FIG. 10.

FIG. 14 is a fourth side view of the embodiment shown in FIG. 10.

FIG. 15 is a first end view of the embodiment shown in FIG. 10.

FIG. 16 is a second end view of the embodiment shown in FIG. 10.

FIG. 17 is a plan view of one connector of the present invention.

FIG. 18 is a side view of the connector of FIG. 17.

FIG. 19 is a plan view of a second connector of the present invention.

FIG. 20 is a side view of the connector of FIG. 19.

FIG. 21 is a plan view of a third connector of the present invention.

FIG. 22 is a side view of the connector of FIG. 21.

FIG. 23 is a perspective view of the connector of FIG. 17.

FIG. 24 is a perspective view of a tool using the second connector.

FIG. 25 is a perspective view of a tool using the third connector.

FIG. 26 is a perspective view of a tool using the first connector.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but on the contrary, the invention is to cover all modifications, alternative constructions, and equivalents falling within the spirit and scope of the invention as defined in the claims.

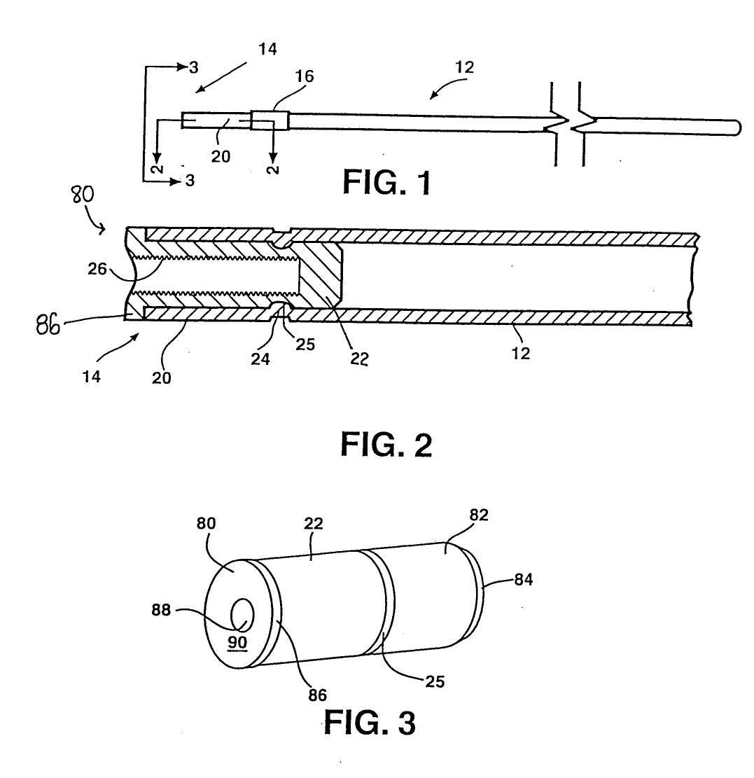

Referring initially to FIG. 1, shown is a first embodiment of the interchangeable drywall tool extension system. Particularly, FIG. 1 shows one embodiment of a handle that can be utilized with the present invention. This handle 12 is of telescoping construction, having a telescoping means 16 such as is standard in the prior art of the type utilizing a handle second portion 20, which slides within a handle first portion 18. The telescoping means 16 is able to lock the handle second portion 20 within the handle first portion 18 at a given length depending upon the wishes and needs of the user. While such a type of telescoping extension pole or handle 12 is disclosed here, all types of means of telescoping extension are also deemed included herein. While the use of a telescoping pole is preferred, the use of non-telescoping poles is also envisioned.

The preferred type of pole is an aluminum, cylindrical pole, having a first end extending to a second end, with at least the first end having an opening at said first end for allowing a bushing to be inserted into said first end. One of the two ends of the handle 12 further comprises a tool connection means 14. This tool connection means 14 allows the handle 12 to be connected to a drywall finishing tool. In the preferred embodiment, this tool connection means 14 comprises a bushing able to be inserted through said opening and into the first end of the pole.

Referring now to FIG. 2, the preferred embodiment of the tool connection means 14 is shown. The preferred handle 12 utilized with this embodiment is of a tubular construction, such as those commonly made out of aluminum, fiberglass, or other materials. Inserted into one of the open ends of the tubular handle 12 is a threaded, generally cylindrical interchangeable head/bushing 22. This bushing 22 is preferably closed at a second end 23 thereby allowing the male threaded portion of an attachment to be threaded snugly to a stop (bottom-out) within the bushing 22. It is preferred that the bushing 22 have a plurality of threads 26 extending therein for interfitting attachment to threads provided on the threaded portion of an attachment. In such a manner, a threaded handle for receiving a threaded attachment is provided.

It is preferred that the bushing 22 be attached within the handle 12 through use of a fastening means 24. The fastening means 24 shown in this embodiment is a crimp or other intrusion into the handle 12, which allows for fitting attachment with a groove 25 in the bushing 22. Other means of attaching or affixing the bushing 22 within the handle 12 are also envisioned, including welding, soldering, adhesives, nuts/bolts, screws, rivets, and other means.

Referring now to FIG. 3, a perspective view of another embodiment of the “head” or bushing 22 of the present invention is shown. The bushing 22 is generally cylindrical in shape and has a first end 80 extending to a second end 82. The second end 82 is for insertion into the open end of a tubular handle. The second end 82 preferably further has a bevel 84 or other rounding for allowing for easier insertion of the second end into the open end of the handle.

This embodiment utilizes a circumvolving or annular groove 25 to assist the attachment means in connecting the bushing 22 to the handle. In such a manner, the handle itself could be crimped or otherwise indented to fit within the groove, thereby inhibiting lateral movement of the bushing within the handle. The bushing first end 80 further defines an opening or orifice 88 there through for receiving the threaded connection end of the attachment utilized with the present invention. In such a manner, a threaded male portion of an attachment can be inserted into the orifice 88 and threaded therein. The first end 80 further comprises a flange 86 or rim for allowing the bushing to be butted against the first end opening of the tubular pole and a first end abutting surface side 90 for abutting the collar of an attachment.

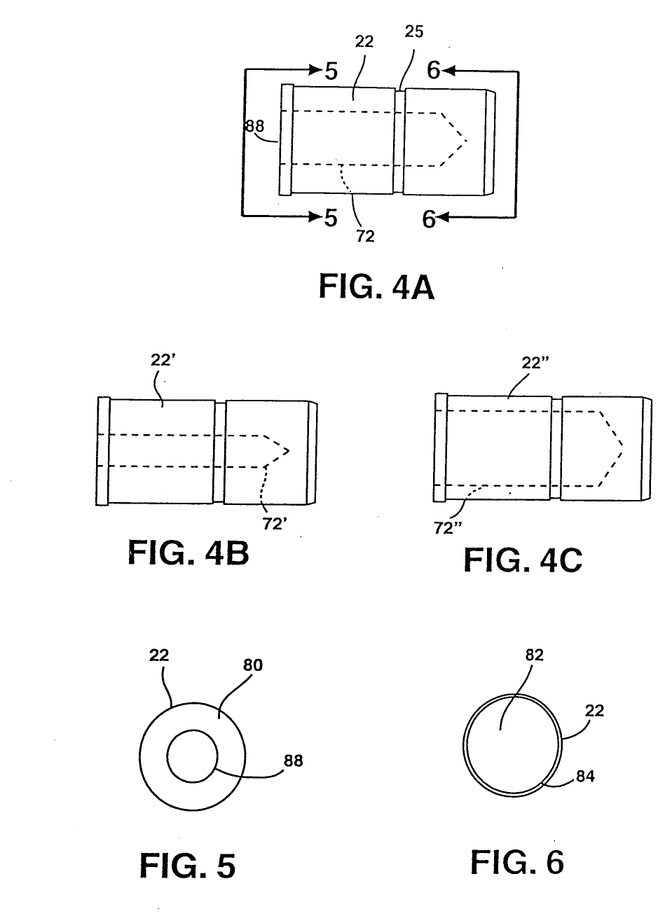

Referring now to FIG. 4A, a side view of another embodiment of a bushing 22 of the present invention is shown. This embodiment shows an attachment groove 25 encircling the bushing 22. The embodiment shows the rim or flange 86 encircling the outer surface of the bushing adjacent the bushing's first end 80. Also shown (in dotted fashion) is an attachment connection 72 extending into the body of the bushing from the attachment connection orifice 88. This attachment connection 72 will preferably be threaded for receiving a threaded male portion of an attachment. As can be seen in comparing FIGS. 4A-4C, this attachment connection 72 (and corresponding threads) located within a particular bushing 22, bushing 22′, bushing 22″ can be of differing diameter and configuration depending upon the diameter and threading of the attachment to be used.

Referring now to FIG. 5, a first end view of the bushing 22 of FIG. 4A is shown. This view shows the bushing 22 having a first end 80 and an attachment orifice 88. This attachment orifice 88 is for receiving there through the threaded attachment of a tool attachment.

In FIG. 6, shown is a second end view of the bushing 22 of FIG. 4A. This figure shows the second end 82 and the bevel 84. While a generally circular handle and bushing is shown in these figures, other shapes would also be envisioned as long as they can be utilized in the same manner.

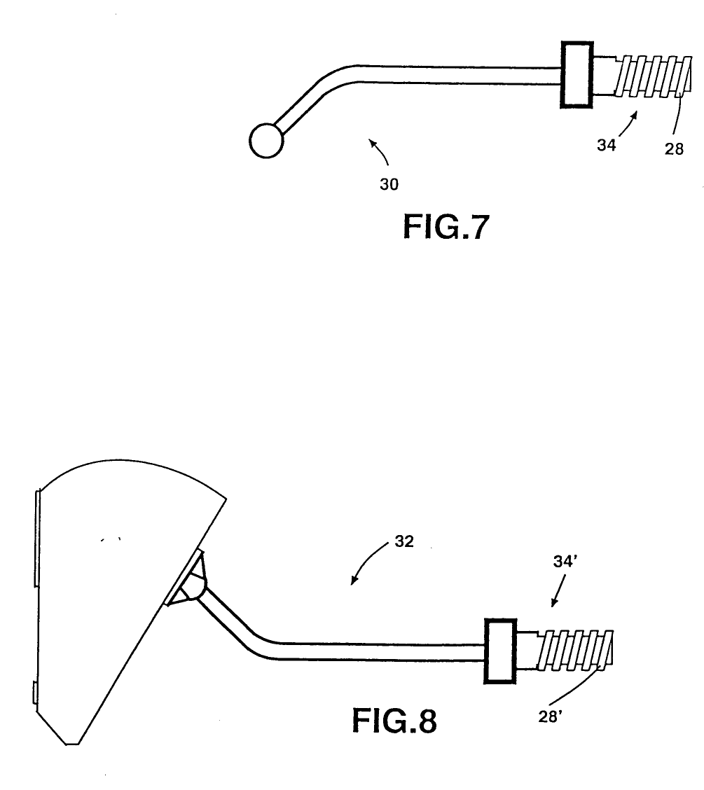

Referring now to FIG. 7, one tool attachment 30 for use with the present invention is disclosed. The tool means or drywall tool attachment 30 shown is a standard of style of attachment means for a corner sander utilized in the industry. This corner sander tool attachment 30 has an attachment portion 34, which is threaded with threading 28, which can be threaded into the bushing 22 shown earlier. Depending on the threading present, any of the various diameters of threadings within different bushing embodiments may need to be utilized (for instance, the user might have three poles, each having a different size threaded bushing therein for allowing for use with multiple different attachments).

Referring now to FIG. 8, a second tool means 32 for use with the present invention is shown. The tool means 32 shown is a standard form of nail spotter used for dabbing spots of finishing compound upon nail or screw holes on drywall surfaces and is commonly known in the industry. This tool means 32 further has an attachment portion 34′ which is threaded with threading 28′ for cooperation with the threads of a bushing 22. Thus, various diameters and types of threaded bushings can be provided, each for receiving therein various types of tool means threaded male portions found in the prior art.

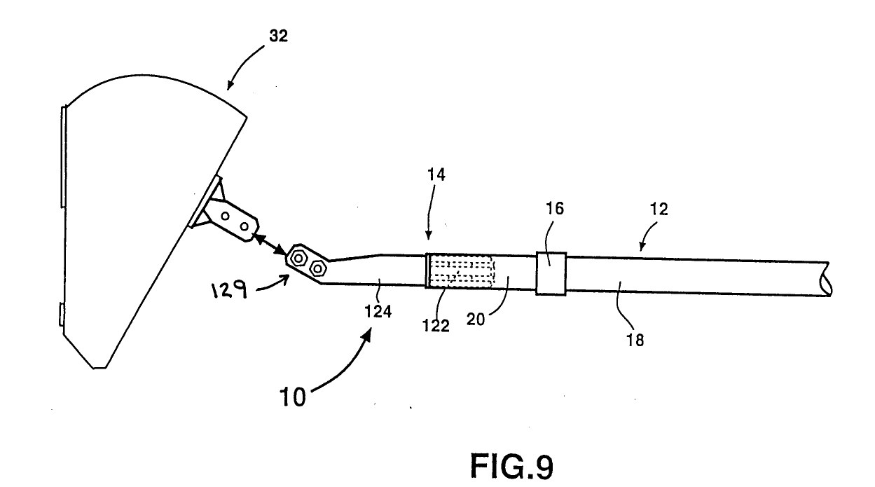

Referring now to FIG. 9, shown is an embodiment of a combination attachment/bushing 122 tool connection means 14 of the present invention. In such an embodiment, the tool attachment portion and the bushing are formed of solitary construction so that the user would remove the attachment portion from an existing tool means and replace it with such a combination attachment/bushing tool connection means. In such a manner, the bushing has extending therefrom and preferably formed thereon, the tool attachment portion. This embodiment likewise utilizes a handle 12, preferably telescoping through use of telescoping means 16 which would allow the handle second portion 20 to slide within the handle first portion 18, thereby allowing the pole to telescope. The bushing 122 of this embodiment has integrated into or attached thereto the attachment means 124 for attaching the present invention with the tool means 32, in the example shown, a nail spotter.

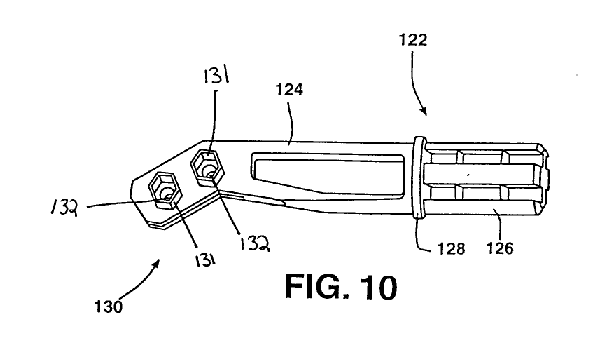

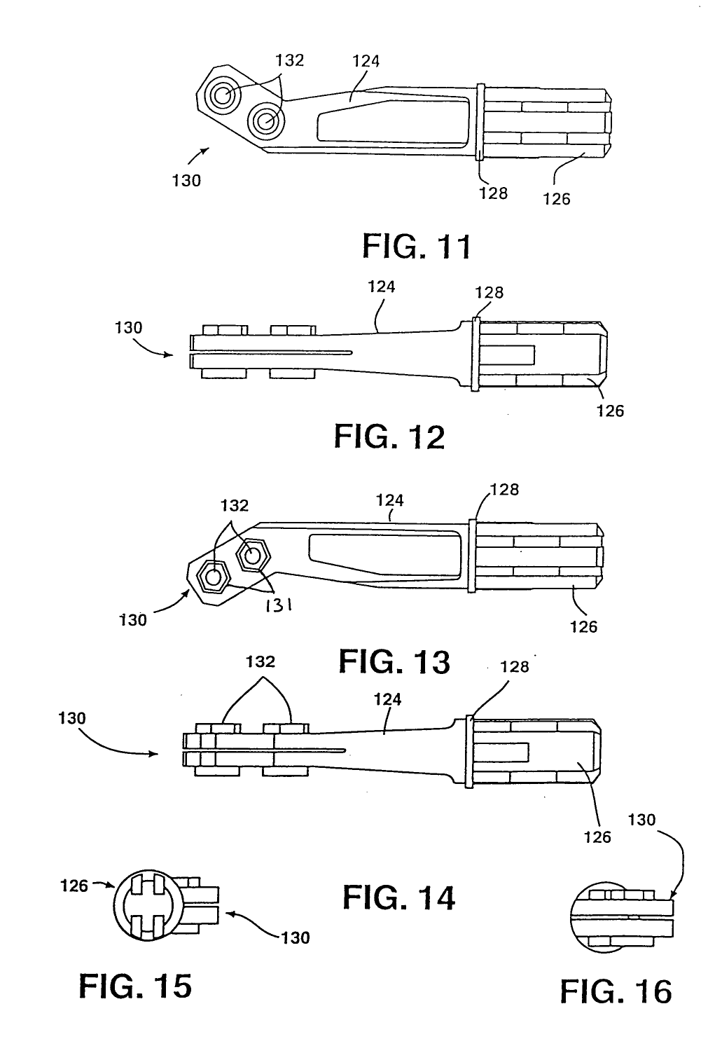

Referring now to FIGS. 10-16, this embodiment of bushing 122 has an insert portion 126 for insertion into the tubular pole. Attachment of the bushing 122 to the pole could be through any number of means, including those discussed above. The preferred attachment is through crimping the side of the pole and causing connection of the pole material with the insert portion 126. The bushing 122 further has a flange 128 for abutment with the end of the pole. The integral attachment means 124 attaching to and extending away from the attachment with the pole may be configured any number of ways.

In the embodiment shown, the attachment means 124 further comprises a tool means attachment 130 for attaching with a tool means, as shown in FIG. 9. In this embodiment, this tool means attachment 130 comprises a slot 129 for receiving therein a flange of the tool means. Bolts or other fastener means could then be utilized to attach the tool means to the tool means attachment. The tool means attachment 130 preferably includes nut walls 131 for holding the edges of nuts (not shown) while screws (not shown) are inserted through the holes 132 defined therein and screwed into said nuts.

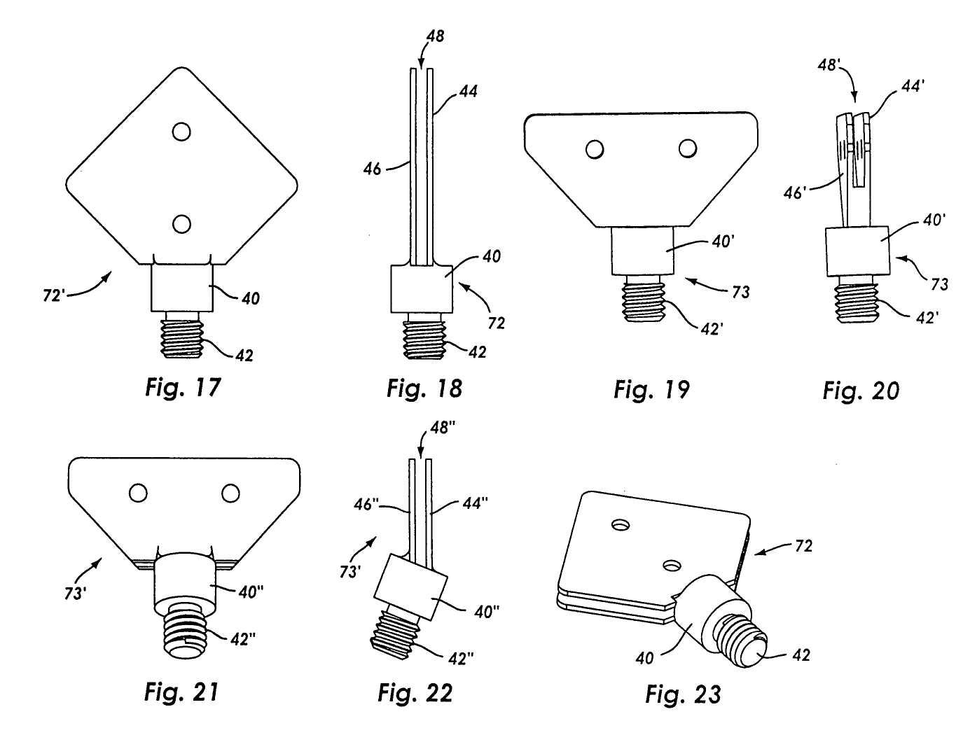

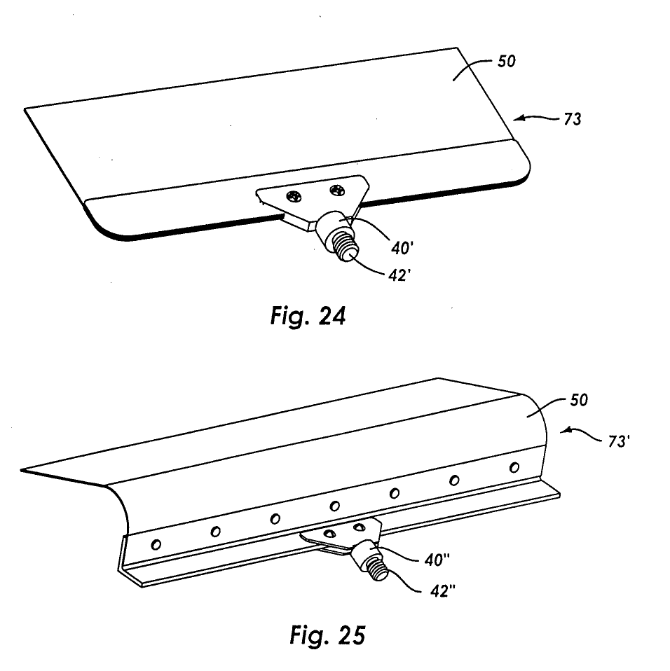

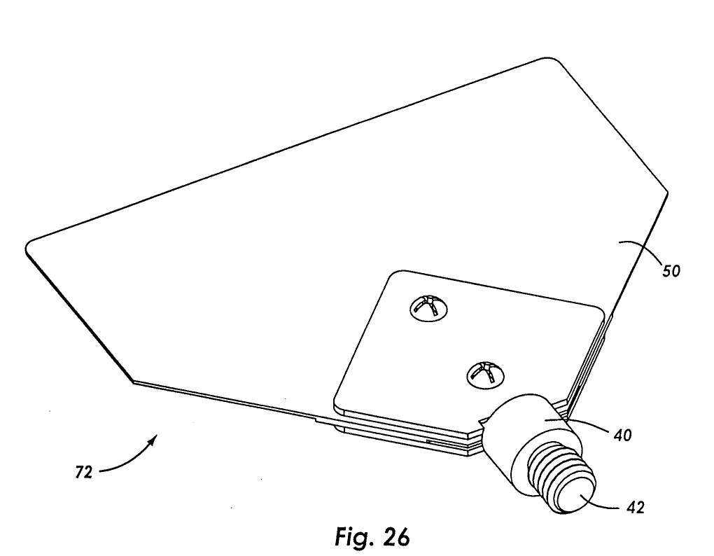

Referring now to FIGS. 17, 18, 23 and 26, shown is a first embodiment of an improved attachment connection 72′ which can be used with the present invention. This attachment connection 72′ having a body 40 having extending there-from a threaded tool head attachment 42 configured for threaded attachment to the bushing 22. The attachment connection 72′ further having a first flange 44 extending from the body 40 generally opposite the threaded tool head attachment 42 and a second flange 46 extending from the body 40 generally opposite the threaded tool head attachment 42. These first and second flanges generally parallel to one another and defining a slot 48 there between. This slot 48 configured for receiving therein a dry wall blade 50.

Referring now to FIGS. 21, 22 and 25, shown is a third embodiment of an improved attachment connection 73′ which can be used with the present invention. This attachment connection 73′ having a body 40″ having extending there-from a threaded tool head attachment 42″ configured for threaded attachment to the bushing 22. The attachment connection 73′ further having a first flange 44″ extending from the body 40″ generally opposite the threaded tool head attachment 42″ and a second flange 46″ extending from the body 40″ generally opposite the threaded tool head attachment 42″. These first and second flanges generally parallel to one another and defining a slot 48″ there-between. This slot 48″ configured for receiving therein a drywall blade 50″.

These attachment connections (72′, 73, 73′) allowing standard drywall blades to be removed from their factory installed handles and reconfigured for use with the present invention through installation on an appropriate attachment connection.

It is envisioned that the present invention will be sold mainly as a specialty telescoping handle already provided with the bushing attached. However, it may be that the bushings will be sold separately for retrofit by consumers into telescoping or other poles. It is envisioned that the threading of the bushings, as well as the tool means attachments disclosed, will preferably be able to receive threaded and other tool means already on the market. Where necessary, the invention may further be packaged with connections that would allow a user to retrofit existing drywall tools that they own with replacement parts having threads able to be threaded into the present invention. While it would be possible for a user to change out the head off of the pole every time the user wanted to switch tools, it is deemed more likely that a user will merely buy a plurality of handles for use with the present invention.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

1. A tool connector for use with an interchangeable tool extension system for allowing a number of tool heads to be interchangeably used with one pole, said interchangeable tool system comprising: a cylindrical tubular pole having a first end extending to a second end; and a cylindrical bushing for connecting a tool head with said pole, said bushing having a cylindrical body able to interfit within said pole first end, said bushing having an outer surface, said outer surface having an annular grove therein, wherein at least one crimp is made in said pole at the location of the bushing groove thereby fixing said bushing within said pole, said bushing having a first end extending to a second end, said bushing first end adjacent said pole first end, said bushing first end defining an opening into said bushing, said opening connecting with a threaded tool head attachment for allowing a tool head having a threaded post to be screwed into said bushing, said tool comprising:
a body having extending there-from a threaded tool head attachment configured for threaded attachment to said bushing;
a first flange extending from said body generally opposite said threaded tool head attachment;
a second flange extending from said body generally opposite said threaded tool head attachment;
said first and second flanges generally parallel to one another, said first and second flanges defining a slot there-between.
